(19) United States
(12) Patent Application Publication
(10) Pub. No.: US 2016/0077850 A1
(43) Pub. Date: Mar. 17, 2016

(54) METHODS, SYSTEMS, AND MEDIA FOR BINARY COMPATIBILITY

(71) Applicant: THE TRUSTEES OF COLUMBIA UNIVERSITY IN THE CITY OF NEW YORK, New York, NY (US)

(72) Inventors: Jeremy Andrus, New York, NY (US); Alexander Van't Hof, New York, NY (US); Naser Alduaij, New York, NY (US); Christoffer Dall, New York, NY (US); Nicolas Viennot, New York, NY (US); Jason Nieh, New York, NY (US)

(21) Appl. No.: 14/785,614

(22) PCT Filed: Apr. 21, 2014
(86) PCT No.: PCT/US14/34825

§ 371 Date: Oct. 19, 2015

Related U.S. Application Data
(60) Provisional application No. 61/814,160, filed on Apr. 19, 2013.
(60) Provisional application No. 61/982,186, filed on Apr. 21, 2014.

(51) Int. Cl. G06F 9/455; G06F 9/45

(52) U.S. Cl. CPC G06F 9/4552; G06F 8/52

(57) ABSTRACT

Methods, systems, and media for binary compatibility comprises: receiving, from a foreign application, a function call to at least one surrogate function, wherein the at least one surrogate function is contained in a surrogate library, and wherein the surrogate library corresponds to a foreign library associated with the foreign function call; identifying a domestic function corresponding to the surrogate function; setting a pointer identifying a block of memory that is local to a thread associated with the surrogate function to point to a first portion of memory associated with the domestic function; invoking the identified domestic function; storing values including one or more error codes returned from the invoked domestic function; setting the pointer to point to a second portion of memory associated with the foreign function call; copying the one or more error codes to the second portion of memory; and continuing to execute the foreign application

### CROSS REFERENCE TO RELATED APPLICATIONS

This application claims the benefit of U.S. Provisional Application No. 61/814,160, filed Apr. 19, 2013, and U.S. Provisional Application No. 61/982,186, filed Apr. 21, 2014, each of which is hereby incorporated by reference herein in its entirety.

### STATEMENT REGARDING FEDERALLY SPONSORED RESEARCH OR DEVELOPMENT

This invention was made with government support under Award Nos. CNS-1162447, CNS-1018355, and CNS-0905246 awarded by the National Science Foundation. The government has certain rights in the invention.

### TECHNICAL FIELD

The disclosed subject matter relates to methods, systems, and media for binary compatibility.

### BACKGROUND

Many people use applications on their mobile devices, such as mobile phones and tablet computers, to play games, read and/or respond to emails, browse the Internet, consume media content, etc. However, these applications are often designed and created to be executed on a particular operating system (e.g., the iOS operating system, the Android operating system, etc.) associated with a particular mobile device. It can therefore be difficult to install and/or run applications created for a mobile device running one operating system on a mobile device running a different operating system. For example, mobile devices running the Android operating system cannot run gaming applications created for the iOS operating system. In another example, mobile device running the iOS operating system cannot access rich multimedia content available in Apple iTunes. This can also limit mobile device users to selecting particular mobile devices that may have smaller screen sizes or other hardware constraints.

Accordingly, it is desirable to provide new methods, systems, and media for binary compatibility.

### SUMMARY

Methods, systems, and media for binary compatibility are provided. In accordance with some embodiments of the disclosed subject matter, a method for binary compatibility is provided, the method comprising: receiving, from a foreign application, a function call having one or more arguments to at least one surrogate function, wherein the at least one surrogate function is contained in a surrogate library, and wherein the surrogate library corresponds to a foreign library associated with the foreign function call; identifying, using a hardware processor, a domestic function corresponding to the at least one surrogate function; setting a pointer identifying a block of memory that is local to a thread associated with the surrogate function to point to a first portion of memory associated with the domestic function; invoking the identified domestic function using the one or more arguments; storing values including one or more error codes returned from the invoked domestic function; setting the pointer to point to a second portion of memory associated with the foreign function call; copying the one or more error codes to the second portion of memory; and continuing to execute the foreign application.

In accordance with some embodiments of the disclosed subject matter, systems for binary compatibility are provided, the systems comprising: a hardware processor that is configured to: receive, from a foreign application, a function call having one or more arguments to at least one surrogate function, wherein the at least one surrogate function is contained in a surrogate library, and wherein the surrogate library corresponds to a foreign library associated with the foreign function call; identify a domestic function corresponding to the at least one surrogate function; set a pointer identifying a block of memory that is local to a thread associated with the surrogate function to point to a first portion of memory associated with the domestic function; invoke the identified domestic function using the one or more arguments; store values including one or more error codes returned from the invoked domestic function; set the pointer to point to a second portion of memory associated with the foreign function call; copy the one or more error codes to the second portion of memory; and continue to execute the foreign application.

In accordance with some embodiments of the disclosed subject matter, non-transitory computer-readable media containing computer executable instructions that, when executed by a processor, cause the processor to perform a method for binary compatibility are provided, the method comprising: receiving, from a foreign application, a function call having one or more arguments to at least one surrogate function, wherein the at least one surrogate function is contained in a surrogate library, and wherein the surrogate library corresponds to a foreign library associated with the foreign function call; identifying a domestic function corresponding to the at least one surrogate function; setting a pointer identifying a block of memory that is local to a thread associated with the surrogate function to point to a first portion of memory associated with the domestic function; invoking the identified domestic function using the one or more arguments; storing values including one or more error codes returned from the invoked domestic function; setting the pointer to point to a second portion of memory associated with the foreign function call; copying the one or more error codes to the second portion of memory; and continuing to execute the foreign application.

In accordance with some embodiments of the disclosed subject matter, a system for binary compatibility is provided, the system comprising: means for receiving, from a foreign application, a function call having one or more arguments to at least one surrogate function, wherein the at least one surrogate function is contained in a surrogate library, and wherein the surrogate library corresponds to a foreign library associated with the foreign function call; means for identifying a domestic function corresponding to the at least one surrogate function; means for setting a pointer identifying a block of memory that is local to a thread associated with the surrogate function to point to a first portion of memory associated with the domestic function; means for invoking the identified domestic function using the one or more arguments; means for storing values including one or more error codes returned from the invoked domestic function; means for setting the pointer to point to a second portion of memory associated with the foreign function call; means for copying the one or more error codes to the second portion of memory; and means for continuing to execute the foreign application.

In some embodiments, generating the surrogate library comprises: means for scanning the foreign library to identify one or more entry points; and means for generating one or more surrogate functions that includes the at least one surrogate function corresponding to the one or more entry points.

In some embodiments, the at least one surrogate function is a wrapper function.

In some embodiments, the system further comprises: means for loading an identified domestic library containing the identified domestic function; means for identifying an entry point of the identified domestic library corresponding to the surrogate function; and means for storing a second pointer to the identified entry point.

In some embodiments, the second pointer is stored in a static variable with local scope.

In some embodiments, the one or more arguments to the function call are stored in a call stack.

In some embodiments, the values returned from the domestic function are stored in a call stack.

In some embodiments, the system further comprises: before invoking the identified domestic function, means for setting an indicator which indicates an execution mode of the thread to a first value associated with the identified domestic function; and after storing the values returned from the invoked domestic function, means for setting the indicator to a second value associated with the foreign function call.

In some embodiments, setting the indicator further comprises means for invoking a system call.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows a schematic diagram of an illustrative system suitable for implementation of mechanisms described herein for binary compatibility in accordance with some embodiments of the disclosed subject matter.

FIG. 2 shows a detailed example of hardware that can be used in a server and/or a user device of FIG. 1 in accordance with some embodiments of the disclosed subject matter.

FIGS. 3A and 3B show examples of architectures of an Android system and an iOS system, respectively, in accordance with some embodiments of the disclosed subject matter.

FIG. 4 shows an example of a process for providing binary compatibility between a foreign system and a domestic system in accordance with some embodiments of the disclosed subject matter.

FIG. 5 shows an example of a system for integrating functionality of a foreign system with a domestic system in accordance with some embodiments of the disclosed subject matter.

FIG. 6 shows an example of an architecture for providing binary compatibility between a foreign system and a domestic system in accordance with some embodiments of the disclosed subject matter.

FIG. 7 shows an example of a process for providing compatibility between a foreign Application Binary Interface (ABI) and a domestic ABI in accordance with some embodiments of the disclosed subject matter.

FIG. 8 shows an example of a process for providing compile-time adaptation of foreign source code in accordance with some embodiments of the disclosed subject matter.

FIG. 9 shows an example of a process for utilizing surrogate functions to call domestic functions from a foreign application in accordance with some embodiments of the disclosed subject matter.

FIG. 10 shows an example of an architecture for providing graphics compatibility between an iOS system and an Android system in accordance with some embodiments of the disclosed subject matter.

### DETAILED DESCRIPTION

In accordance with various embodiments, mechanisms (which can include methods, systems, and media) for enacting a foreign function call are provided.

In accordance with some embodiments, the mechanisms described herein can allow foreign binaries associated with a foreign application to run on a user device using a domestic operating system. More particularly, the mechanisms described herein can allow a foreign binary that has been developed for a foreign operating system different than the domestic operating system executing on a mobile device to execute on the mobile device, which has both the domestic and the foreign operating systems. As described herein, a foreign binary refers to a binary file (e.g., a completely functional program, as opposed to source code, or a portion of source code) developed for a foreign operating system, that is, an operating system other than the operating system executing on the user device. Additionally, as used herein, a domestic binary refers to a binary file developed for a domestic operating system, that is, the operating system executing on the user device.

In some embodiments, the mechanisms described herein can provide compatibility between the foreign operating system and the domestic operating system by modifying a kernel associated with the domestic operating system. For example, the mechanisms can modify a domestic kernel by allowing the domestic kernel to be aware of both foreign and domestic threads executing on the domestic system. As a more particular example, the mechanisms can define a persona as an execution mode that is assigned to a thread, which can indicate whether the thread is associated with foreign or domestic code. As another more particular example, the mechanisms described herein can receive a foreign system call, map the foreign system call to a domestic system call (e.g., by translating calling conventions associated with the foreign system call to those associated with the corresponding domestic system call), and invoke the remapped system call.

In some embodiments, the mechanisms described herein can allow foreign source code to be directly compiled into the kernel associated with the domestic system, thereby allowing the resulting foreign binaries to use kernel services that were not originally present in the kernel of the domestic system. For example, the mechanisms can include a compile-time code adaptation layer that allows unmodified foreign kernel code to be directly compiled into the kernel of the domestic system.

Additionally or alternatively, in some embodiments, the mechanisms described herein can allow a function call from a foreign application to use domestic libraries and/or domestic function calls by creating a surrogate wrapper function for the foreign function call, which can then invoke the domestic function call. In this manner, the mechanisms described herein can remap foreign function calls which access proprietary software and/or hardware associated with the foreign system to domestic function calls which interface with software and/or hardware associated with the user device.

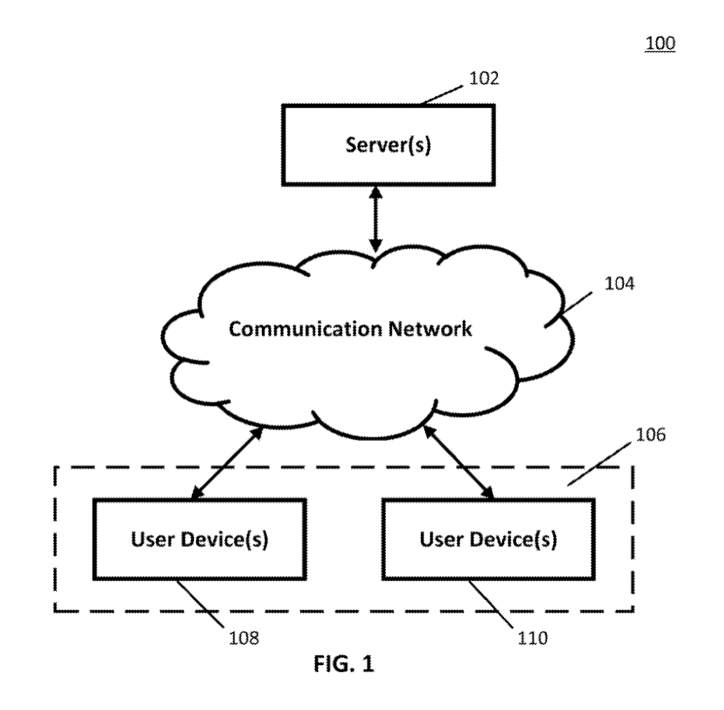

Turning to FIG. 1, an example 100 of hardware for binary compatibility that can be used in accordance with some embodiments of the disclosed subject matter is shown. As illustrated, hardware 100 can include one or more servers 102, a communication network 104, and one or more user devices 106, such as user devices 108 and 110.

Server(s) 102 can be any suitable servers for providing access to the mechanisms described herein for enacting foreign functions calls, such as a processor, a computer, a data processing device, or any suitable combination of such devices. For example, in some embodiments, server(s) 102 can transmit mobile device applications to a user device, for example, via communication network 104. As another example, in some embodiments, server(s) 102 can generate surrogate libraries used to allow a foreign application running on a domestic system to call domestic functions, and/or transmit the surrogate libraries to user device 106 via communication network 104.

Communication network 104 can be any suitable combination of one or more wired and/or wireless networks in some embodiments. For example, communication network 206 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 106 can be connected by one or more communications links to communication network 104 that can be linked via one or more communications links to server(s) 102. The communications links can be any communications links suitable for communicating data among user devices 106 and server(s) 102, such as network links, dial-up links, wireless links, hard-wired links, any other suitable communications links, or any suitable combination of such links.

User devices 106 can include any one or more user devices suitable for running foreign and/or domestic applications and for implementing the mechanisms described herein for binary compatibility. For example, in some embodiments, user devices 106 can be implemented as a mobile device, such as a mobile phone, a tablet computer, a laptop computer, a vehicle (e.g., a car, a boat, an airplane, or any other suitable vehicle) entertainment system, a portable media player, and/or any other suitable mobile device. As another example, in some embodiments, user devices 106 can be implemented as a non-mobile device such as a desktop computer, a set-top box, a television, a streaming media player, a game console, and/or any other suitable non-mobile device.

Although two user devices 108 and 110 are shown in FIG. 1 to avoid over-complicating the figure, any suitable number of user devices, and/or any suitable types of user devices, can be used in some embodiments.

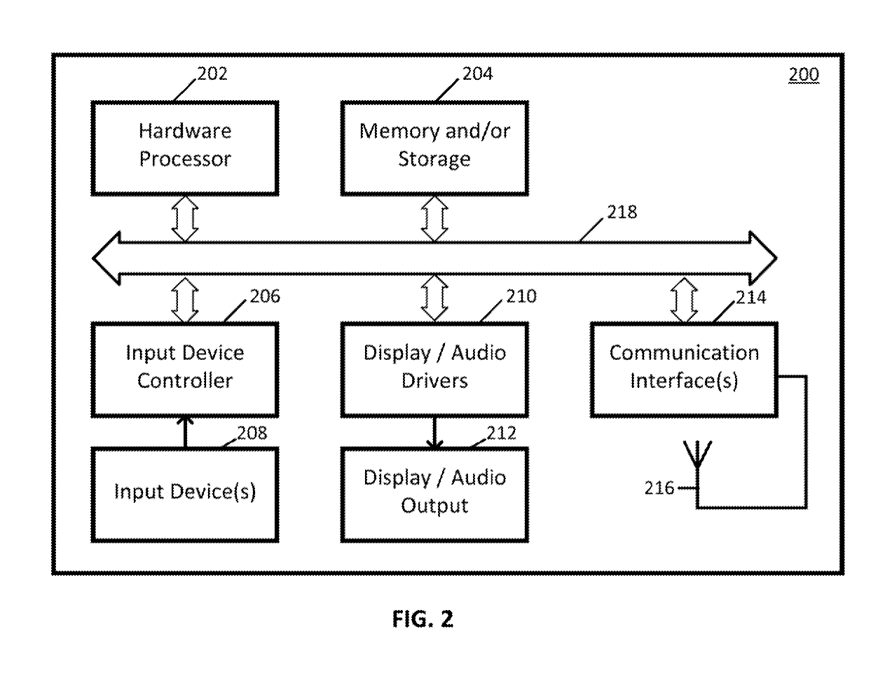

Server(s) 102 and user devices 106 can be implemented using any suitable hardware in some embodiments. For example, in some embodiments, devices 102 and 106 can be implemented using any suitable general purpose computer or special purpose computer. For example, a mobile phone may be implemented using a special purpose computer. Any such general purpose computer or special purpose computer can include any suitable hardware. For example, as illustrated in example hardware 200 of FIG. 2, such hardware can include hardware processor 202, memory and/or storage 204, an input device controller 206, an input device 208, display/audio drivers 210, display and audio output circuitry 212, communication interface(s) 214, an antenna 216, and a bus 218.

Hardware processor 202 can include any suitable hardware processor, such as a microprocessor, a micro-controller, digital signal processor(s), dedicated logic, and/or any other suitable circuitry for controlling the functioning of a general purpose computer or a special purpose computer in some embodiments.

Memory and/or storage 204 can be any suitable memory and/or storage for storing programs, data, media content, and/or any other suitable information in some embodiments. For example, memory and/or storage 204 can include random access memory, read-only memory, flash memory, hard disk storage, optical media, and/or any other suitable memory.

Input device controller 206 can be any suitable circuitry for controlling and receiving input from one or more input devices 208 in some embodiments. For example, input device controller 206 can be circuitry for receiving input from a touchscreen, from a keyboard, from a mouse, from one or more buttons, from a voice recognition circuit, from a microphone, from a camera, from an optical sensor, from an accelerometer, from a temperature sensor, from a near field sensor, and/or any other type of input device.

Display/audio drivers 210 can be any suitable circuitry for controlling and driving output to one or more display/audio output devices 212 in some embodiments. For example, display/audio drivers 210 can be circuitry for driving a touchscreen, a flat-panel display, a cathode ray tube display, a projector, a speaker or speakers, and/or any other suitable display and/or presentation devices.

Communication interface(s) 214 can be any suitable circuitry for interfacing with one or more communication networks, such as network 104 as shown in FIG. 1. For example, interface(s) 214 can include network interface card circuitry, wireless communication circuitry, and/or any other suitable type of communication network circuitry.

Antenna 216 can be any suitable one or more antennas for wirelessly communicating with a communication network (e.g., communication network 104) in some embodiments. In some embodiments, antenna 216 can be omitted.

Bus 218 can be any suitable mechanism for communicating between two or more components 202, 204, 206, 210, and 214 in some embodiments.

Any other suitable components can be included in hardware 200 in accordance with some embodiments.

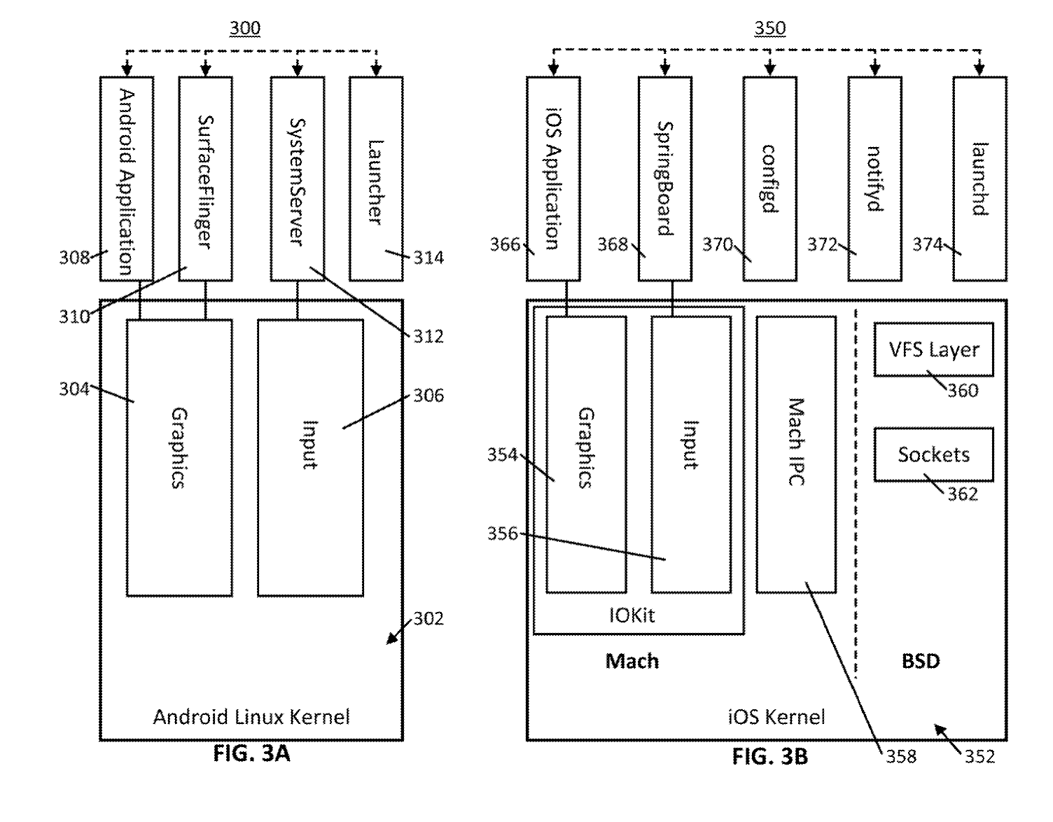

In some embodiments, hardware 200 can be used in an architecture corresponding to a particular operating system. For example, FIGS. 3A and 3B show examples of architectures of an Android system (FIG. 3A) and of an iOS system (FIG. 3B), respectively.

As shown in FIG. 3A, Android architecture 300 can include an Android Linux kernel 302, an Android application 308, and one or more support libraries, such as SurfaceFlinger library 310, SystemServer library 312, and Launcher application 314.

Android Linux kernel 302 can be any suitable kernel on which the Android system is built, and can include any suitable releases. As shown in FIG. 3A, Android Linux kernel 302 can include a graphics module 304 and an input module 306. In some embodiments, graphics module 304 and input module 306 can be used to communicate with and receive communication from a user of a user device 106 that is running the Android system. For example, in some embodiments, graphics module 304 can cause one or more icons representing applications to be presented on a display output (e.g., a touchscreen, a monitor, and/or any other suitable display output) of user device 106. As another example, in some embodiments, graphics module 304 can cause graphics (e.g., images, icons, animations, movies, and/or any other suitable graphics) to be presented on the display output of user device 106. In some embodiments, graphics module 304 can include a Graphics Processing Unit (GPU). As yet another example, in some embodiments, input module 306 can be used to receive inputs from a user (e.g., taps and/or swipes on a touchscreen, clicks, and/or any other suitable inputs).

Android application 308 can be any application created for the Android system. Android application 308 can have any suitable purpose. For example, in some embodiments, Android application 308 can be an e-mail application, a media player, a game, an application which calculates and presents directions in response to a request, and/or any other suitable application. In some embodiments, Android application 308 can be created by and/or provided by any suitable entity (e.g., an individual person, a group of people, a corporation, and/or any other suitable entity). Note that although only one Android application is shown in FIG. 3A, in some embodiments, any suitable number of Android applications can be included (e.g., one, two, five, ten, and/or any other suitable number), each of which can be in a different activity state (e.g., running in an active mode, running in a background mode, and/or any other suitable activity state).

In some embodiments, SurfaceFlinger library 310, SystemServer library 312, and Launcher application 314 can be used to provide application services, graphics, input, and/or any other suitable functions. For example, in some embodiments, SystemServer library 312 can cause Launcher application 314 to be called and/or executed, thereby causing a homescreen of user device 106 to be initiated. As another example, in some embodiments, SurfaceFlinger library 310 can cause one or more display interfaces (e.g., icons, widgets, and/or any other suitable display interfaces) to be presented on a display output of user device 106 using a GPU in graphics module 304. As yet another example, SurfaceFlinger library 310 can allow Android application 308 to render graphics by providing Android application 308 with window memory in the form of a display surface. Android application 308 can then draw directly into the window memory, for example, by causing OpenGL code to be rendered using a GPU in graphics module 304. Note that although three support libraries and/or applications (e.g., libraries 310 and 312, and application 314) are shown in FIG. 3A, these are merely illustrative. In some embodiments, any suitable number of support libraries and/or applications (e.g., one, two, five, ten, and/or any other suitable number) providing any suitable functions can be included.

Turning to FIG. 3B, an example 350 of an iOS architecture is illustrated in accordance with some embodiments. As shown, iOS architecture 350 can include an iOS kernel 352, an iOS application 366, a SpringBoard application 368, and user space daemons, such as launchd daemon 374, configd daemon 370, and notifyd daemon 372.

In some embodiments, iOS kernel 352 can be any suitable kernel on which the iOS system is built (e.g., the XNU kernel), and can include any suitable releases. As shown in FIG. 3B, iOS kernel 352 can include a graphics module 354 and an input module 356. In some embodiments, graphics module 354 and input module 356 can be used to communicate with and receive communication from a user of a user device 106 running the iOS system. Similarly to graphics module 304 and input module 306 of the Android system, graphics module 354 can cause any suitable graphics (e.g., icons, animations, images, and/or any other suitable graphics) to be presented on user device 106, and input module 356 can receive any suitable input from user device 106.

In some embodiments, iOS kernel 352 can be built on the XNU kernel, which is a hybrid kernel architecture based on features of a monolithic kernel architecture, such as a monolithic Berkeley Standard Distribution (BSD) kernel, and a microkernel architecture, such as a Mach microkernel, running in a single address space. In some embodiments, iOS kernel 352 can include Mach IPC module 358, which can be used to provide inter-process communication (IPC) services between programs and/or processes running on the iOS system. Additionally, in some embodiments, iOS kernel 352 can include VFS layer 360 and/or BSD sockets 362. In some such embodiments, VFS layer 360 can be used to provide an abstraction layer to an iOS file system, and BSD sockets 362 can be used to provide additional IPC services between programs and/or processes.

In some embodiments, SpringBoard application 368 can be used to display a homescreen for the iOS system on user device 106, which can present icons, widgets, and/or any other suitable items.

In some embodiments, SpringBoard application 368 can be launched and/or started from launchd daemon 374. In some such embodiments, launchd daemon 374 can boot the iOS system, and can start, stop, and/or maintain services and applications. In addition to starting SpringBoard application 368, in some embodiments, launchd daemon 374 can start services associated with Mach IPC module 358, such as configd daemon 370 and notifyd daemon 372, which is an asynchronous notification server. Note that although only four support applications and/or services (SpringBoard application 368, configd daemon 370, notifyd daemon 372, and launchd daemon 374) are shown in FIG. 3B, these are merely illustrative. Any suitable support applications and/or services can be included in some embodiments.

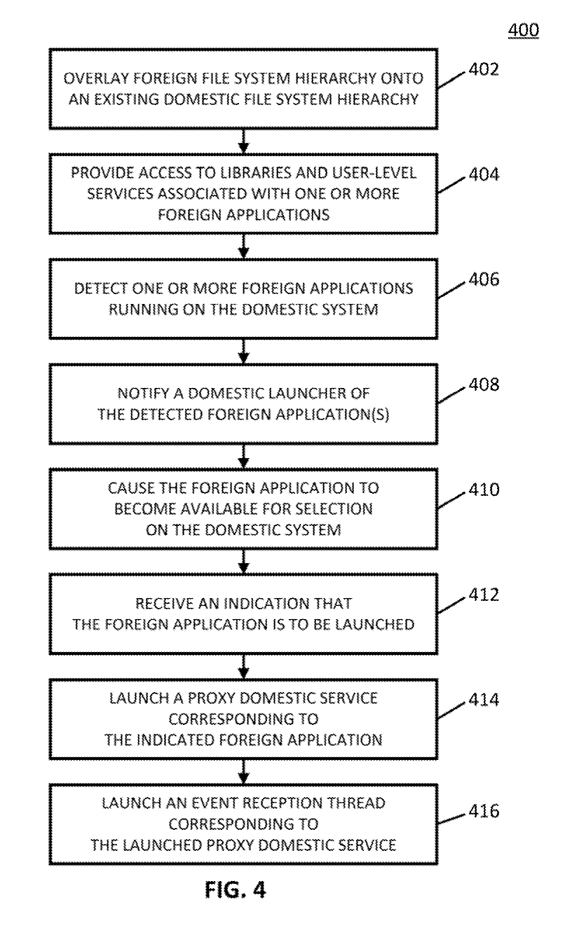

Turning to FIG. 4, an example 400 of a process for running a foreign application on a domestic operating system is illustrated in accordance with some embodiments. In some embodiments, process 400 can be executed on any suitable user device 106. Note that, in some embodiments, the domestic operating system can include any operating system (e.g., an Android operating system, an iOS operating system, and/or any other suitable operating system) implemented on a user device executing process 400. Similarly, in some embodiments, the foreign application can be created for any foreign operating system which is different from the domestic operating system.

Process 400 can begin by placing a foreign file system hierarchy associated with the foreign operating system onto a domestic file system hierarchy associated with the domestic operating system at 402. By overlaying the foreign file system hierarchy onto the domestic file system hierarchy, the foreign operating system can access files using existing paths known to the foreign operating system, while allowing domestic applications to function without interruption. Additionally, existing paths can be accessed without running a kernel associated with the foreign operating system and without running foreign applications which are used for displaying the homescreen on the foreign system (e.g, SpringBoard application 368). The foreign file system hierarchy can be overlaid onto the domestic file system hierarchy in any suitable manner. For example, in some embodiments, process 400 can create file system entries corresponding to the foreign operating system within the file system corresponding to the domestic operating system. As a more particular example, in some embodiments, process 400 can create subdirectories (e.g., “/Applications,” “/Documents,” “/Library,” “/System/Library,” and/or any other suitable subdirectories) used for running foreign applications in the file system of the domestic operating system. In some embodiments, a view of a file system can be changed by using personas to switch between the foreign file system and the domestic file system using any suitable technique (e.g., a “chroot” operation that changes the root directory, file system unioning, and/or any other suitable technique).

Process 400 can provide access to libraries and user-level services associated with one or more foreign applications at 404 using any suitable technique or combination of techniques. For example, in some embodiments, existing binaries from the foreign operating system can be copied to the domestic operating system. In instances where existing binaries cannot be copied from the foreign operating system to the domestic operating system, process 400 can combine binaries from the foreign operating system with binaries and/or core framework libraries from one or more other development environments (e.g., a Xcode Software Development Kit, or “SDK”, and/or any other suitable development environment).

Process 400 can detect and/or identify one or more foreign applications running on the domestic operating system at 406 using any suitable technique or combination of techniques. As a more particular example, in an instance where the domestic operating system is an Android system, process 400 can detect one or more foreign applications by using a kernel subsystem or any other suitable portion of the framework to detect foreign applications (e.g., iOS applications, and/or any other suitable foreign applications) or other file system events, such as the Linux “inotify” framework.

After detecting the one or more foreign applications, process 400 can notify a domestic launcher application of the detected foreign application(s) at 408 using any suitable technique or combination of techniques. In the specific example where the domestic system is an Android system, process 400 can transmit a notification to Launcher application 314 of the detected foreign application(s).

Process 400 can cause the detected foreign application(s) to become available for selection on the homescreen of user device 106 at 410 using any suitable technique or combination of techniques. In the specific example where the domestic system is an Android system, process 400 can cause the detected foreign application(s) to become available by causing Launcher application 314 to place one or more icons corresponding to the detected foreign application(s) on the homescreen of user device 106. In some embodiments, process 400 can extract icons and/or other elements related to the foreign application from a package associated with the foreign application, and process 400 can make the extracted icon(s) and/or other elements available to Launcher application 314 for placement on the homescreen.

Process 400 can receive an indication that the foreign application is to be launched at 412. The indication can be received based on any suitable information. For example, in some embodiments, process 400 can receive an indication that an icon associated with the foreign application was selected (e.g., touched on a touchscreen, clicked with a mouse, and/or any other suitable selection input) from an input module associated with the domestic system (e.g., input module 306).

Process 400 can launch a proxy domestic service corresponding to the launched foreign application at 414. In some embodiments, the proxy domestic service can be a standard application which can run on the domestic system. In such embodiments, the proxy domestic service can behave like any other domestic application. For example, in some embodiments, the proxy domestic service can receive events similarly to other domestic applications, be listed in an activity list associated with the domestic system, and/or have any other suitable capabilities. In the specific example where the domestic system is an Android system, the proxy domestic service can be launched by Launcher application 314. Additionally or alternatively, in some embodiments, a separate and/or individual copy of the proxy domestic service can be launched for each launched foreign application.

The proxy domestic service can perform any suitable functions. For example, in some embodiments, the proxy domestic service can control execution of the foreign application, by, for example, running an associated foreign binary and integrating execution of the foreign application on the domestic system with background user-level services of the foreign system. In the specific example where the foreign application is an iOS application, the proxy domestic service can facilitate initiation of iOS binary applications by issuing Java Native Interface (JNI) calls to call the unmodified iOS “launchctl” command, which can request that launchd daemon 374 (FIG. 3) run the iOS application, thereby allowing the proxy domestic service to replicate the application launch mechanism of the foreign system. As another example, in some embodiments, the proxy domestic service can transmit associated display memory to the foreign application. In some such embodiments, display memory transmitted from the proxy domestic service can be used to present screen shots of the foreign application in an activity list displayed on the user device. As yet another example, in instances where the foreign application is an iOS application, process 400 can use Process Identification (PID) virtualization to set a perceived PID associated with launchd daemon 374 to 1, as is assumed by the iOS application.

Process 400 can launch an event reception thread associated with the launched proxy domestic service at 416. In some embodiments, the launched event reception thread can receive events from the proxy domestic service (which can, in some embodiments, receive events from a BSD socket) and can forward the received events to the foreign application. The received events can include any suitable events detected based on any suitable input. For example, in some embodiments, the events can include the foreign application becoming idle and/or going into a background mode, a display associated with the user device running the foreign application rotating, receiving user input (e.g., from a keyboard, a touchscreen, an accelerometer, a microphone, and/or any other suitable input), and/or any other suitable events. Process 400 can launch the event reception thread using any suitable technique or combination of techniques. For example, in some embodiments, process 400 can launch the event reception thread as a per-application thread at a known point in the startup procedure of the foreign application.

Through coordination between the proxy domestic service and the event reception thread, process 400 can monitor and/or respond to any received events, thereby allowing the foreign application to run on the domestic system while responding to received events.

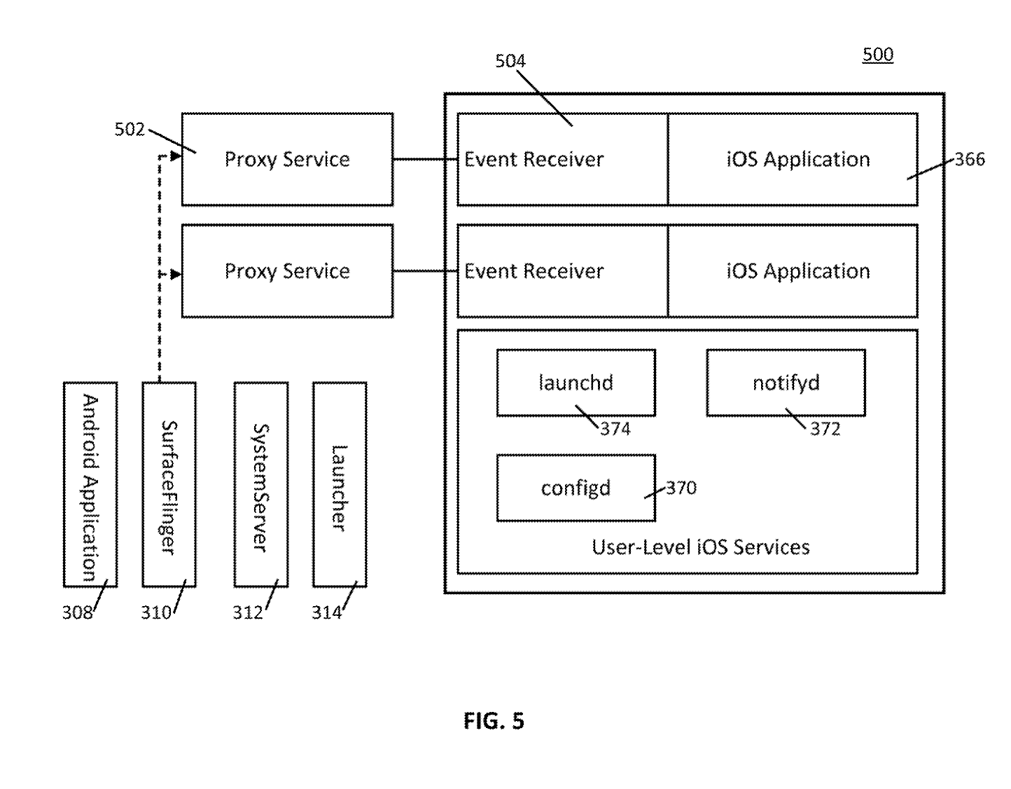

Turning to FIG. 5, an example 500 of a system for integrating functionality of a foreign system with a domestic system is illustrated in accordance with some embodiments. In the specific example of system 500, the foreign system is an iOS system, and the domestic system is an Android system. As shown in FIG. 5, system 500 can include domestic support libraries and/or applications (e.g., SurfaceFlinger library 310, SystemServer library 312, and Launcher application 314) as described above in connection with FIG. 3A, user-level foreign system services (e.g., configd daemon 370, notifyd daemon, launchd daemon 374) as described above in connection with FIG. 3B, and a foreign application (e.g., iOS application 366) as described above in connection with FIG. 3B. In some embodiments, system 500 can additionally include proxy domestic services (e.g., proxy domestic service 502) and event receivers (e.g., event receiver 504).

Proxy domestic service 502 can include any suitable functions and/or processes for controlling execution of the foreign application and coordinating execution of the foreign application with domestic support libraries and/or applications (e.g., SurfaceFlinger library 310, SystemServer library 312, Launcher application 314, and/or any other suitable libraries and/or applications) as described above in connection with block 414 of FIG. 4. Although two proxy domestic services are shown in FIG. 5, this is merely illustrative. In some embodiments, any suitable number (e.g., one, two, five, ten, and/or any other suitable number) can be included.

Event receiver 504 can be any suitable event reception thread for receiving events from proxy domestic service 502 and forwarding the received events to iOS application 366, as described above in connection with block 416 of FIG. 4. Note that, in some embodiments, event receiver 504 can have a one-to-one correspondence with proxy domestic service 502, as well as a one-to-one correspondence with iOS application 366.

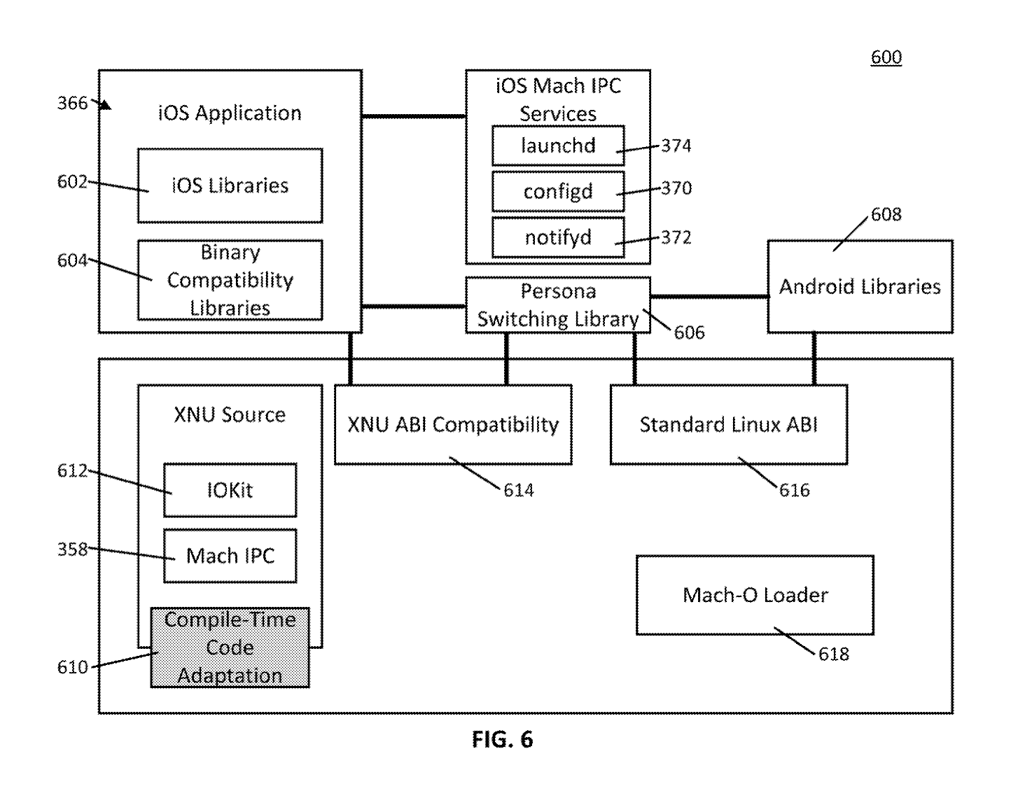

Turning to FIG. 6, an example 600 of an architecture for running unmodified foreign binaries on a domestic system is illustrated in accordance with some embodiments. In the specific example of architecture 600, the foreign system is an iOS system, and the domestic system is an Android system.

In some embodiments, architecture 600 can allow code from a foreign binary to be imported into a domestic system. For example, since the iOS system is built on an open-source XNU kernel, architecture 600 can allow source code from the XNU kernel to be imported into an Android system, which can allow substantial portions of an iOS Application Binary Interface (ABI) to be implemented on the Android system. As a more particular example, in some embodiments, architecture 600 can import I/O Kit library 612, which can be used for development of device drivers for the iOS system.

Additionally or alternatively, in some embodiments, architecture 600 can run unmodified foreign binaries on the domestic system using four components (e.g., kernel ABI compatibility, API interposition, compile-time adaptation of foreign source code, and use of surrogate functions to call domestic functions from a foreign application) which provide binary compatibility between the foreign and domestic systems. Although architecture 600 illustrates the four components, in some embodiments, any of the four components can be omitted. Additionally or alternatively, in some embodiments, additional components can be included.

Furthermore, in some embodiments, any suitable number of the four components can be combined to provide binary compatibility between the foreign and domestic systems.

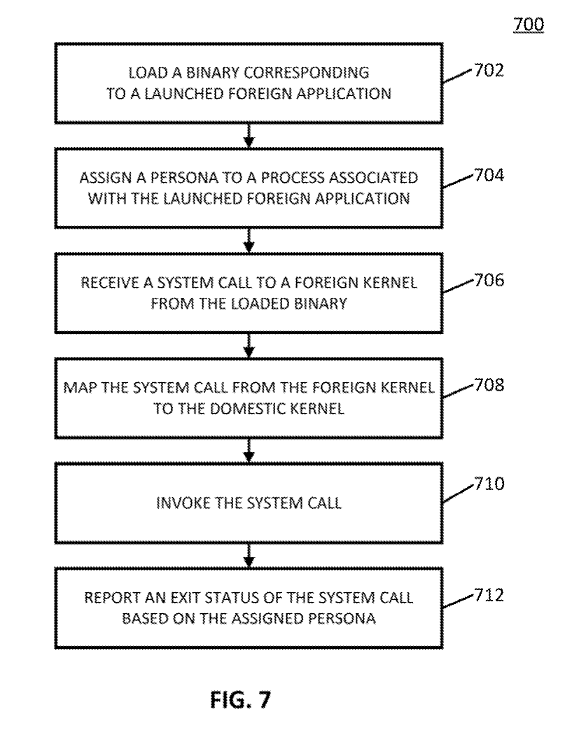

First, in some embodiments, architecture 600 can provide compatibility between the XNU ABI and a Linux ABI on an Android system by modifying the Linux kernel ABI. For example, in some embodiments, the Linux kernel ABI can modified using XNU ABI compatibility module 614, Standard Linux ABI module 616, and Mach-O loader 618. As a more particular example, in some embodiments, Mach-O loader 618 can be used to load one or more iOS binaries on the Linux kernel. In some such embodiments, a wrapper function that maps system calls from foreign iOS binaries can be mapped to corresponding Linux system calls by first mapping arguments from XNU structures to Linux structures, then by calling corresponding Linux system calls and/or by reusing existing Linux kernel Application Programming Interfaces (APIs). An example of a process for providing kernel ABI compatibility is described below in connection with FIG. 7.

Second, in some embodiments, architecture 600 can provide an API interposition layer. In some embodiments, the API interposition layer can support system calls that can be implemented in user space using existing foreign source code in combination with Linux system calls. As a specific example, the BSD “kqueue” and “kevent” notification functions, which allow for user space to be notified of kernel events, are provided by the XNU kernel of the iOS system. Since the data semantics to register for and receive event notifications are specific to iOS subsystems, the addition of support for the “kqueue” and “kevent” functions in the Android system would require changes to many core subsystems of the Linux kernel. In some embodiments, the API interposition layer included in architecture 600 can configure an environment variable to load iOS libraries 602 (e.g., iOS libraries including functions such as “kqueue” and “kevent”), thereby allowing the foreign source code contained in iOS libraries 602 to be used on the domestic (e.g., Android) system. Additionally or alternatively, in some embodiments, API interposition can be used to launch an event receiver thread (e.g., as shown in and described above in connection with FIG. 5) by hooking into a foreign application at a known point and launching the event receiver thread at the known point.

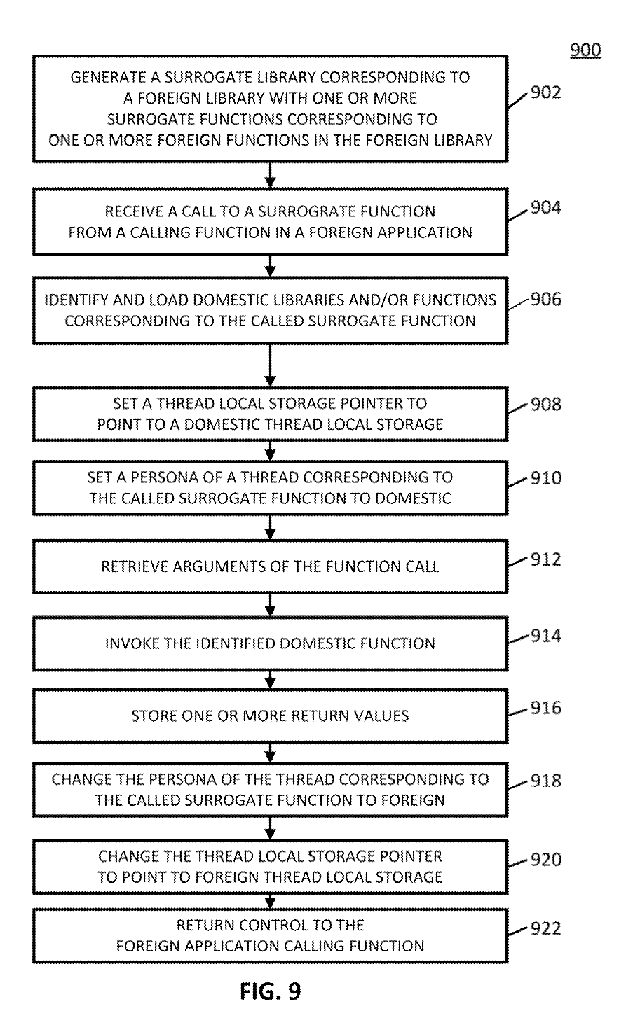

In some embodiments, architecture 600 can combine API interposition with a mechanism (sometimes referred to herein as a “passport system call”) to allow a foreign thread to access a domestic system call. In some embodiments, passport system calls can allow a thread associated with a foreign binary to indirectly call a domestic system call. For example, architecture 600 can use the API interposition layer to allow foreign kernel serves to be implemented in user space using existing domestic services via passport system calls to export the foreign API to the foreign binary. Foreign applications that require kernel-level services not available to the domestic operating system can then be executed. Note that unlike the surrogate function calls shown in and described below in connection with FIG. 9, which execute domestic user space binaries within a foreign binary (including the issuing of all domestic system calls), passport system calls can allow the issuance of specifically-identified domestic system calls from a foreign binary. In some embodiments, API interposition can be combined with passport system calls to provide foreign kernel subsystems, such as the “kqueue” and “kevent” event notification subsystems described above, foreign APIs which support prioritized workqueue threads (e.g., the iOS pthread workqueues), and/or any other suitable foreign kernel subsystems.

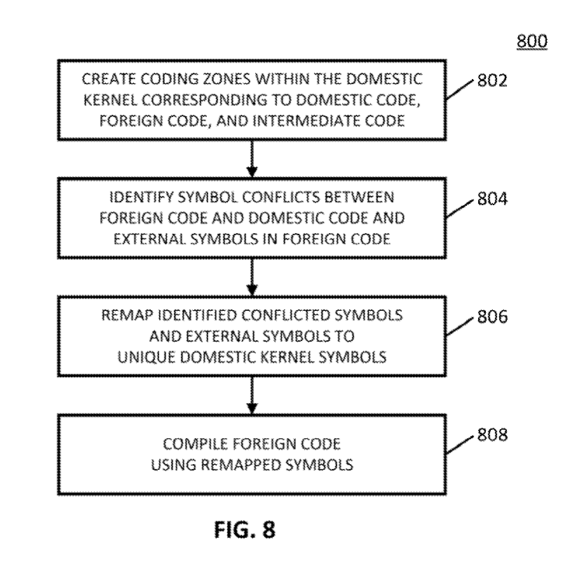

Third, in some embodiments, architecture 600 can include a compile-time code adaptation layer 610, which can allow unmodified binaries associated with a foreign kernel to be directly compiled into the domestic kernel, thereby allowing the foreign binaries to use kernel services not otherwise present in the domestic kernel. An example of a process for implementing compile-time code adaptation layer 610 is described below in connection with FIG. 8.

Fourth, in some embodiments, architecture 600 can include a persona switching library 606 which can allow a foreign application to use a surrogate function (e.g., a wrapper function) to call a domestic function. The persona switching library can therefore provide support for applications that use closed foreign libraries which issue system calls specific to a device running the foreign system by allowing a foreign application to use domestic libraries (e.g., Android libraries 608) to interact with hardware (e.g., a touchscreen, a keyboard, and/or any other suitable hardware) specific to a user device running the domestic system. An example of a process for allowing a foreign application to use domestic libraries is described below in connection with FIG. 9.

In some embodiments, architecture 600 can be implemented using components of hardware 200. For example, in some embodiments, files (e.g., source code, binary files, data files, and/or any other suitable file types) associated with components of architecture 600 (e.g., iOS libraries 602, binary compatibility libraries 604, persona switching library 606, Android libraries 608, compile-time adaptation layer 610, Mach-O loader 618, and/or any other suitable components) can be stored in memory 204. As another example, in some embodiments, the processes implemented by compile-time code adaptation layer 610 and/or persona switching library 606 can be executed by hardware processor 202.

Turning to FIG. 7, an example 700 of a process for providing compatibility between a foreign ABI and a domestic ABI is illustrated in accordance with some embodiments.

Process 700 can begin by loading a foreign binary format file corresponding to a launched foreign application at 702. The foreign binary can be loaded using any suitable technique or combination of techniques. For example, in an instance where the foreign system is an iOS system (which can use a Mach-O format for binary files) and the domestic system is an Android system, process 700 can use a Mach-O loader (e.g., Mach-O loader 618, as shown in and described above in connection with FIG. 6) to load the iOS binary file on the Linux kernel of the Android system. In some such embodiments, any suitable Mach-O loader can be used. In some embodiments, process 700 can be configured to automatically use a particular Mach-O loader upon detecting that an iOS binary is to be executed.

Process 700 can assign an indicator (referred to hereinafter as a “persona”) to a thread executed by the foreign library at 704. In some embodiments, the persona can indicate any suitable information, such as whether the thread is running as a foreign or domestic thread, one or more identification numbers associated with the process and/or threads within the process, and/or any other suitable information. In some embodiments, the persona can be assigned using a system call. In the particular example where the domestic system is an Android system running on a Linux kernel, process 700 can track assigned personas on a per-thread basis using the “task struct” function. Additionally, in some embodiments, personas can be inherited when processes are copied either partially or fully (e.g., using “fork” and/or “clone”).

It should be noted that personas can be tracked on a per-thread basis, thereby allowing an application process with multiple threads to support multiple personalities.

Process 700 can receive a system call to a foreign kernel from the loaded foreign binary at 706. For example, in instances where the foreign system is an iOS system, process 700 can receive a system call specific to the XNU ABI of the iOS system. The received system call can include any suitable information and/or requests for services from the foreign binary to the kernel. In some embodiments, process 700 can determine which foreign kernel the system call is directed to based on the persona assigned at block 704.

Process 700 can map the received system call from the foreign kernel to the domestic kernel at 708. The system call can be mapped using any suitable technique or combination of techniques. For example, in some embodiments, process 700 can translate a calling convention associated with the foreign kernel to a calling convention associated with the domestic kernel. As a more particular example, in some embodiments, process 700 can evaluate the persona associated with an executing thread to determine that the thread is an iOS process, and process 700 can subsequently map the calling conventions associated with an iOS system call to the calling conventions associated with, for example, the Linux ABI of an Android system. In some embodiments, process 700 can map system calls from a convention associated with the foreign kernel to a convention associated with the domestic kernel using system call dispatch tables configured for each persona. The system call dispatch table can then be switched depending on a persona associated with the calling thread, and information such as function parameters and/or CPU flags can be translated to the convention associated with the domestic kernel using the dispatch table, thereby allowing a corresponding domestic system call to be directly invoked with the translated parameters and/or flags.

As another example, in some embodiments, process 700 can create a wrapper function for the received system call, such that the wrapper function maps the arguments of the system call from structures associated with the foreign system to structures associated with the domestic system. As a more particular example, in instances where the foreign system is an iOS system and the domestic system is an Android system, process 700 can create a wrapper function which maps arguments from XNU structures to Linux structures. Additionally or alternatively, in some embodiments, process 700 can create a wrapper function which reuses existing domestic kernel functions to implement the received foreign system call. As a more particular example, in instances where the foreign system is an iOS system and the domestic system is an Android system, and where the foreign system call is one which creates a child process from a specified process (e.g., “posix spawn”), process 700 can create a wrapper function which uses the existing Linux system calls “clone” and “exec.”

Process 700 can invoke the mapped foreign system call on the domestic system at 710. In some embodiments, the invoked system call can have any suitable arguments and any suitable number of arguments. Additionally, in some embodiments, the invoked system call can return any suitable return values.

Process 700 can report an exit status of the invoked system call at 712. In some embodiments, the exit status can be received as a signal from a domestic kernel, for example, an asynchronous signal generated in response to an event such as an illegal instruction and/or a segmentation fault. In some embodiments, process 700 can evaluate a persona of a thread (e.g., the persona assigned at block 704) associated with the invoked system call on its return path to user space, and process 700 can then report the exit status based on the determined persona. For example, some system calls to the XNU kernel return error indications through flags associated with the Central Processing Unit (CPU), whereas corresponding system calls to the Linux kernel return negative integers to indicate an error status. By evaluating a persona of a thread (e.g., to determine if the thread is running in a foreign mode or in a domestic mode), process 700 can appropriately handle the returned exit status. For example, in instances where the domestic system is an Android system and an error signal is received from a Linux kernel, process 700 can translate the received error signal into one that would have been generated by the foreign system (e.g., the XNU kernel in instances where the foreign system is an iOS system). In some embodiments, the translated error signal can then be delivered to the foreign application. In some embodiments, the exit status can include any suitable error codes (e.g., “errno,” and/or any other suitable error codes).

In some embodiments, the wrapper functions described above in connection with FIG. 7 are not suitable for implementing a foreign binary. For example, foreign system calls can require subsystems that do not exist in the domestic system. As a more particular example, the Mach IPC subsystem is used extensively for inter-process communication on the iOS system, but is missing from the Linux kernel of the Android system. FIG. 8 shows an example 800 of a process for directly compiling foreign source code into a domestic kernel to address this problem. In some embodiments, process 800 can compile foreign kernel APIs related to synchronization, memory allocation, process control, list management, and/or any other suitable services into domestic kernel APIs. The resulting cross-compiled module and/or subsystem can then be accessed by both foreign and domestic applications. In some embodiments, process 800 can be included in compile-time adaptation layer 610, as shown in and described above in connection with FIG. 6.

Process 800 can begin by creating distinct coding zones within the domestic kernel at 802. In some embodiments, three distinct coding zones can be created, corresponding to domestic, foreign, and intermediate zones, respectively. In some such embodiments, source code in the domestic zone can be restricted from accessing symbols in the foreign zone, and vice versa. Furthermore, source code in both the foreign and domestic zones can access symbols in the intermediate zone, and source code in the intermediate zone can access symbols in both the foreign and domestic zones.

Process 800 can identify symbol conflicts between the source code in the foreign zone and source code in the domestic zone at 804.

Process 800 can remap the identified conflicted symbols in the foreign zone to unique symbols at 806. Additionally, in some embodiments, process 800 can remap external symbols in the foreign source code to appropriate domestic kernel symbols. In some embodiments, process 800 can remap the conflicted symbols and the external foreign symbols through preprocessor tokens and/or static in-line functions located in the intermediate zone.

Process 800 can compile the foreign source code using the remapped symbols at 808. In some embodiments, any suitable compiler can be used to compile the foreign source code into the domestic kernel. In instances where foreign dependencies cannot be easily remapped, process 800 can implement one or more of the processes of the foreign dependencies in the intermediate and/or domestic zones before compiling the remaining foreign source code into the domestic kernel.

In instances where the foreign system is an iOS system, process 800 can be used to provide support for subsystems available in the XNU kernel within the Linux kernel of the Android system. For example, in some embodiments, process 800 can be used to compile libraries associated with user space priority threads in the iOS system. As a more particular example, in some embodiments, process 800 can compile the open-source library “bsd/kern/pthread support.c” into the domestic kernel, thereby allowing foreign iOS applications to use mutexes, semaphores, condition variables, etc. supported by the library. As another example, in some embodiments, process 800 can be used to compile the majority of the Mach IPC subsystem of the iOS system into the Linux kernel of the Android system. In some such embodiments, portions of the Mach IPC subsystem that are unsuitable for direct compilation into the foreign Linux kernel can be reimplemented. As a more particular example, since the XNU kernel stack defaults to 16 KB, which is twice as large as the Linux kernel stack, in some embodiments, queuing structures in XNU source code can be reimplemented to interface with the Linux kernel environment, thereby allowing foreign applications using the XNU Mach IPC source code to use deep call stacks to access queuing structures recursively. As yet another example, in some embodiments, process 800 can be used to implement the I/O Kit device driver framework, as described below.

In some embodiments, a foreign application may make use of closed foreign libraries and/or proprietary hardware specific to user devices running the foreign system. For example, the OpenGL ES libraries on both Android and iOS systems directly communicate with GPUs on their respective systems through proprietary software and hardware interfaces, for example, the “ioctls” system call on the Android system and opaque IPC message on the iOS system. In such embodiments, the foreign libraries cannot be supported directly by the domestic kernel (e.g., by using process 700) and cannot be directly compiled into the domestic kernel (e.g., by using process 800), because the foreign libraries may be closed and/or because the foreign libraries interface with hardware not present on the domestic system. To address this problem, FIG. 9 shows an example 900 of a process for temporarily allowing a thread from a process executing in a foreign application to execute domestic functions from within the foreign application in accordance with some embodiments. Note that, in some embodiments, process 900 can be included in persona switching library 606 as shown in and described above in connection with FIG. 6.

Process 900 can begin by generating a surrogate library corresponding to a foreign library at 902. In some embodiments, the surrogate library can contain one or more surrogate functions which correspond to one or more foreign functions contained in the foreign library. Process 900 can use any suitable technique or combination of techniques to generate the surrogate library. For example, in some embodiments, process 900 can scan the foreign library for entry points and can generate a surrogate function (e.g., a wrapper function) for each identified entry point. In some embodiments, process 900 can replace the foreign library with the generated surrogate library by dynamically loading the surrogate library instead of the foreign library, thereby allowing function calls to the foreign library to be intercepted by the surrogate functions of the surrogate library. Note that, in some embodiments, the surrogate library can be generated by a process other than process 900. For example, in some embodiments, the surrogate library can be generated by a process running on server 102, and the surrogate library can then be transmitted to a user device (e.g., user device 106) running process 900, for example, via communication network 104.

Process 900 can receive a function call to one or more of the surrogate functions in the surrogate library from a foreign function of a foreign application at 904. In some embodiments, the function call can have any suitable number of arguments (e.g., zero, one, two, five, and/or any other suitable number). In some embodiments, the arguments associated with the received function call can be stored on a stack associated with the function call.

Process 900 can identify and load domestic libraries and/or domestic functions corresponding to the called surrogate function, and can locate an appropriate entry point to the identified domestic function at 906 using any suitable technique or combination of techniques. For example, in some embodiments, process 900 can load and interpret the domestic binaries using any suitable dynamic binary loader associated with the domestic system. As a more particular example, in instances where the domestic system is an Android system, the dynamic binary loader can be any suitable version of the Android Executable and Linkable Format (ELF) loader. As another example, in some embodiments, process 900 can identify the entry point to the domestic function and can store a pointer to the entry point, thereby allowing the determination of the entry point to be reused for subsequent calls to the surrogate function. As a more particular example, in some embodiments, the pointer to the entry point can be stored in a static variable. In some such embodiments, the static variable can have a scope local to the surrogate function.

Process 900 can set a pointer identifying a block of memory that is local to a thread associated with the surrogate function (e.g., thread-local storage) to point to a location in memory associated with the domestic function at 908.

Process 900 can set a persona of the thread associated with the surrogate function to a value that indicates that the thread is currently executing in a domestic mode at 910. As described above in connection with FIG. 7, in some embodiments, the persona of the thread can be set using a system call. As a more particular example, in some embodiments, the persona of the thread can be set using a passport system call, as described above in connection with FIG. 6.

Process 900 can retrieve arguments associated with the function call at 912. In embodiments in which the arguments were stored on a stack associated with the function call at block 904, process 900 can retrieve the stored arguments from the stack.

Process 900 can invoke the domestic function identified at block 906 using the retrieved arguments at 914. In some embodiments, process 900 can invoke the domestic function call using the pointer to the entry point of the domestic function identified and stored at block 906.

Process 900 can store one or more values returned from the domestic function call at 916. In some embodiments, process 900 can store the return value(s) on a stack associated with the function call.

Process 900 can change the persona of the thread to a different value that indicates that the thread is to switch back to executing in foreign mode at 918. Similarly to block 910, in some embodiments, process 900 can change the persona of the thread using a system call (e.g., a passport system call, and/or any other suitable type of system call). In some embodiments, any values stored in a block of memory local to the executing thread (e.g., in thread-local storage) can be copied into a portion of memory associated with the foreign function (e.g., a foreign thread-local storage). The copied values can include any suitable values, such as return values, values indicating errors and/or exit status of the thread (e.g., “errno,” and or any other suitable values).

Process 900 can then return control to the foreign application at 922. The foreign application can then continue to execute.

In some embodiments, any of the processes described in connection with FIGS. 7, 8, and/or 9 can be implemented in architecture 600. In some embodiments, architecture 600 can provide binary compatibility for a variety of applications and/or services by using any of the processes (or any suitable combination of the processes) of FIGS. 7, 8, and/or 9. For example, the above-mentioned techniques can be used to provide support for foreign subsystems including hardware devices, input from a user device running a foreign application, graphics, etc.

As a more particular example, in some embodiments, architecture 600 can use compile-time adaptation layer 610 and/or process 800 to make underlying hardware devices available via I/O Kit to iOS applications running on an Android system in a manner similar to the manner in which I/O kit is used on the iOS system. Specifically, architecture 600 can compile the I/O Kit framework by adding a C++ runtime to the Linux kernel. The Linux kernel C++ runtime can then be used to directly compile the majority of the I/O Kit code found in the XNU “iokit” source directory. Architecture 600 can then make hardware devices available through either the domestic Linux device driver framework or the foreign I/O Kit. More specifically, architecture 600 can create an I/O kit registry entry for every registered Linux device (e.g., by using a hook in the Linux “device_add” function, and/or using any other suitable function(s)), and architecture 600 can then provide an I/O Kit driver class that interfaces with the corresponding registered Linux devices. In this manner, foreign iOS applications running on a domestic Android system can use I/O Kit to query the I/O Kit registry to locate and/or access hardware devices.

As another more particular example, in some embodiments, architecture 600 can use one or more event reception threads (as shown in and described above in connection with FIGS. 4 and 5) to read events from input devices associated with a domestic system, translate the events into a format associated with a foreign application, and send the events to a port used by the foreign application to receive input events. Specifically, an event reception thread can detect events (e.g., a keypress, a touch and/or swipe on a touchscreen, a display rotating, and/or any other events as described above in connection with FIGS. 4 and 5) on a BSD socket. The event reception thread can then translate the detected events to a format associated with an iOS application, and can then send the translated events to the iOS application via a Mach IPC port. Architecture 600 can therefore support input received on Android system hardware for use on an iOS application.

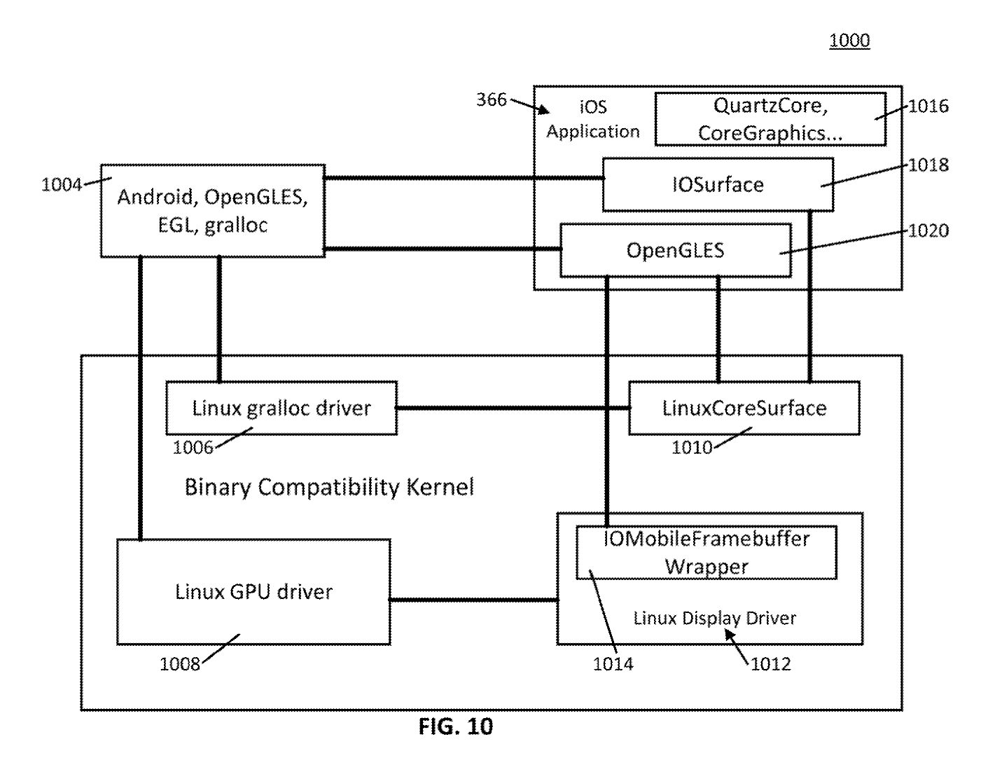

As yet another more particular example, in some embodiments, architecture 600 can use a combination of the processes of FIGS. 7, 8, and 9 to provide binary compatibility for 2D and 3D graphics. FIG. 10 shows an example 1000 of an architecture for providing graphics compatibility between a foreign iOS system and a domestic Android system.

As shown in FIG. 10, an iOS application can, in some embodiments, use libraries such as QuartzCore library 1016, IOSurface library 1018, and OpenGLES library 1020. These libraries can in turn call closed source and/or proprietary libraries, which make opaque calls via Mach IPC to closed source kernel drivers. In some such embodiments, the closed source kernel drivers can control the hardware on which graphics are displayed.

Architecture 1000 can allow foreign iOS application to implement 2D graphics on the domestic Android system through a combination of techniques. In some embodiments, an unmodified QuartzCore library 1016 can be used by architecture 1000. In some embodiments, architecture 1000 can use API interposition (as described above in connection with FIG. 6) to interpose on IOSurface library 1018 in order to allocate the graphics memory needed to use the unmodified Android gralloc library (e.g., contained in Android libraries 1004) and underlying Linux gralloc driver 1006. In some embodiments, architecture 1000 can use API interposition and surrogate function calls (e.g., process 900 as shown in and described above in connection with FIG. 9) to the Android gralloc library to tie the allocated graphics memory to Android GraphicBuffer objects designed to be shared between graphics hardware via OpenGL ES and the CPU via direct pixel manipulation. In some embodiments, instead of using the IOMobileFrameBuffer of the iOS system to cause the graphics to be displayed, architecture 1000 can create an IOMobileFrameBuffer wrapper 1014 around an existing Linux display driver 1012, which can communicate with a Linux GPU driver 1008. Additionally, in some embodiments, architecture 1000 can include a LinuxCoreSurface module 1010 to provide zero-copy semantics expected by IOSurface library 1018. In such embodiments, LinuxCoreSurface module 1010 can be a reverse-engineered IOCoreSurface I/O Kit driver.

Additionally or alternatively, in some embodiments, architecture 1000 can allow foreign iOS applications to implement 3D graphics on the domestic Android system through use of surrogate functions (e.g., as described above in connection with FIG. 9) to call domestic Android graphics libraries from a foreign iOS application. For example, architecture 1000 can replace OpenGL ES library 1020 in its entirety by using surrogate functions to call Android graphics libraries (e.g., in Android library module 1004). As iOS OpenGL ES library 1020 consists of a standard OpenGL ES API and proprietary EAGL extensions, architecture 1000 can provide a surrogate library with surrogate entry points for every exported symbol in both the standard OpenGL ES API and the proprietary EAGL extensions. As a more particular example, architecture 1000 can provide surrogate functions which call the Android Open GL ES library (e.g., in Android library module 1004). More specifically, in some embodiments, architecture 1000 can create the surrogate functions using an automated script that analyzes exported symbols in the iOS OpenGL ES Mach-O library, searches through a directory of Android ELF shared objects for a matching export, and automatically generates the surrogate function. As another more particular example, architecture 1000 can use surrogate function calls to the Android EGL functions (e.g., in Android library module 1004) to implement the proprietary EGL extensions. Architecture 1000 can then use the Android EGL functions in combination with SurfaceFlinger service 310 (as described above in connection with FIG. 3) to manage memory associated with windows into which graphics from foreign iOS applications are rendered.

In some embodiments, at least some of the above described blocks of the processes of FIGS. 4, 7, 8, and 9 can be executed or performed in any order or sequence not limited to the order and sequence shown in and described in connection with the figures. Also, some of the above blocks of FIGS. 4, 7, 8, and 9 can be executed or performed substantially simultaneously where appropriate or in parallel to reduce latency and processing times. Additionally or alternatively, some of the above described blocks of the processes of FIGS. 4, 7, 8, and 9 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, methods, systems, and media for binary compatibility are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for binary compatibility, comprising:
receiving, from a foreign application, a function call having one or more arguments to at least one surrogate function, wherein the at least one surrogate function is contained in a surrogate library, and wherein the surrogate library corresponds to a foreign library associated with a foreign function call;
identifying, using a hardware processor, a domestic function corresponding to the at least one surrogate function;
setting a pointer identifying a block of memory that is local to a thread associated with the surrogate function to point to a first portion of memory associated with the domestic function;
invoking the identified domestic function using the one or more arguments;
storing values including one or more error codes returned from the invoked domestic function;
setting the pointer to point to a second portion of memory associated with the foreign function call;
copying the one or more error codes to the second portion of memory; and
continuing to execute the foreign application.

2. The method of claim 1, wherein generating the surrogate library comprises:
scanning the foreign library to identify one or more entry points; and
generating one or more surrogate functions that includes the at least one surrogate function corresponding to the one or more entry points.

3. The method of claim 1, wherein the at least one surrogate function is a wrapper function.

4. The method of claim 1, further comprising:
loading an identified domestic library containing the identified domestic function;
identifying an entry point of the identified domestic library corresponding to the surrogate function; and
storing a second pointer to the identified entry point.

5. The method of claim 4, wherein the second pointer is stored in a static variable with local scope.

6. The method of claim 1, further comprising:
before invoking the identified domestic function, setting an indicator which indicates an execution mode of the thread to a first value associated with the identified domestic function; and
after storing the return value from the invoked domestic function, setting the indicator to a second value associated with the foreign function call.

7. The method of claim 6, wherein setting the indicator further comprises invoking a system call.

8. A system for binary compatibility, the system comprising:
a hardware processor that is configured to:
receive, from a foreign application, a function call having one or more arguments to at least one surrogate function, wherein the at least one surrogate function is contained in a surrogate library, and wherein the surrogate library corresponds to a foreign library associated with a foreign function call;
identify a domestic function corresponding to the at least one surrogate function;
set a pointer identifying a block of memory that is local to a thread associated with the surrogate function to point to a first portion of memory associated with the domestic function;
invoke the identified domestic function using the one or more arguments;
store values including one or more error codes returned from the invoked domestic function;
set the pointer to point to a second portion of memory associated with the foreign function call;
copy the one or more error codes to the second portion of memory; and
continue to execute the foreign application.

9. The system of claim 8, wherein the hardware processor is further configured to:
scan the foreign library to identify one or more entry points; and
generate one or more surrogate functions that includes the at least one surrogate function corresponding to the one or more entry points.

10. The system of claim 8, wherein the at least one surrogate function is a wrapper function.

11. The system of claim 8, wherein the hardware processor is further configured to:
load an identified domestic library containing the identified domestic function;
identify an entry point of the identified domestic library corresponding to the surrogate function; and
store a second pointer to the identified entry point.

12. The system of claim 11, wherein the second pointer is stored in a static variable with local scope.

13. The system of claim 8, wherein the hardware processor is further configured to:
before invoking the identified domestic function, set an indicator which indicates an execution mode of the thread to a first value associated with the identified domestic function; and
after storing the return value from the invoked domestic function, set the indicator to a second value associated with the foreign function call.

14. The system of claim 13, wherein setting the indicator further comprises invoking a system call.

15. A non-transitory computer-readable medium containing computer executable instructions that, when executed by a processor, cause the processor to perform a method for binary compatibility, the method comprising:
receiving, from a foreign application, a function call having one or more arguments to at least one surrogate function, wherein the at least one surrogate function is contained in a surrogate library, and wherein the surrogate library corresponds to a foreign library associated with a foreign function call;
identifying a domestic function corresponding to the at least one surrogate function;
setting a pointer identifying a block of memory that is local to a thread associated with the surrogate function to point to a first portion of memory associated with the domestic function;
invoking the identified domestic function using the one or more arguments;
storing values including one or more error codes returned from the invoked domestic function;
setting the pointer to point to a second portion of memory associated with the foreign function call;
copying the one or more error codes to the second portion of memory; and
continuing to execute the foreign application.

16. The non-transitory computer-readable medium of claim 15, wherein generating the surrogate library comprises:
scanning the foreign library to identify one or more entry points; and
generating one or more surrogate functions that includes the at least one surrogate function corresponding to the one or more entry points.

17. The non-transitory computer-readable medium of claim 15, wherein the at least one surrogate function is a wrapper function.

18. The non-transitory computer-readable medium of claim 15, wherein the method further comprises:
loading an identified domestic library containing the identified domestic function;
identifying an entry point of the identified domestic library corresponding to the surrogate function; and
storing a second pointer to the identified entry point.

19. The non-transitory computer-readable medium of claim 18, wherein the second pointer is stored in a static variable with local scope.

20. The non-transitory computer-readable medium of claim 15, further comprising:
before invoking the identified domestic function, setting an indicator which indicates an execution mode of the thread to a first value associated with the identified domestic function; and
after storing the return value from the invoked domestic function, setting the indicator to a second value associated with the foreign function call.

21. The non-transitory computer-readable medium of claim 20, wherein setting the indicator further comprises invoking a system call.
